(19) United States
(12) Patent Application Publication
(10) Pub. No.: US 2016/0381462 A1
(43) Pub. Date: Dec. 29, 2016

(54) Speaker

(71) Applicants: Hongxing Wang, Shenzhen (CN); Lubin Mao, Shenzhen (CN)

(72) Inventors: Hongxing Wang, Shenzhen (CN); Lubin Mao, Shenzhen (CN)

(73) Assignee: AAC Technologies Pte. Ltd., Singapore City (SG)

(21) Appl. No.: 15/006,397

(22) Filed: Jan. 26, 2016

(30) Foreign Application Priority Data
Jun. 23, 2015 (CN) 201520433884.X

(51) Int. Cl. H04R 9/02; H04R 7/18; H04R 9/06

(52) U.S. Cl. CPC H04R 9/025; H04R 9/06; H04R 7/18; H04R 2209/024; H04R 2207/00; H04R 2499/11

(57) ABSTRACT

A speaker is disclosed in the present disclosure. The speaker includes a vibration system including a vibrating diaphragm and a flat voice coil for driving the vibrating diaphragm; a magnetic circuit system including a first permanent magnet and a second permanent magnet, which are separated with opposite magnetic poles thereof facing each other; a magnetic gap formed between the first permanent magnet and the second permanent magnet for partially receiving the flat voice coil; and a housing for accommodating the vibrational system and the magnetic circuit system. Two magnetic poles of the first permanent magnet and two magnetic poles of the second permanent magnet are close to each other respectively, N-pole of the first permanent magnet is separated from and faces S-pole of the second permanent magnet, while S-pole of the first permanent magnet is separated from and faces N-pole of the second permanent magnet.

### FIELD OF THE INVENTION

The present disclosure relates to electro-acoustic transducers, more particularly to a speaker having a diaphragm driven by a voice coil.

### DESCRIPTION OF RELATED ART

With the rapid development of technology, audio devices are more and more popular. The people require not only the audio playing function of the audio devices, but also require higher reliability of audio devices. As more mobile multimedia technologies are developed particularly in 3G era, many audio devices are provided with many entertainment features, such as video playback, digital camera, games, GPS navigation and so on, more sophisticated and compact electronic components are required in audio devices.

The speaker is a common electronic component in audio devices and is used mainly for playback of audio signals. In the existing audio devices, the thickness of mobile phone, for example, is smaller, so that the speaker shall be thinner also. If the speaker is too thin, the vibration amplitude of the vibrating diaphragm is reduced, that will affect seriously the low frequency performance of the speaker. Therefore, the existing long stroke speaker with better low frequency performance is developed and the thickness is small enough, so that such a speaker can solve well the problems of traditional speaker. The magnetic circuit system of the long stroke speaker includes usually two pairs of magnets separated each other as drive magnets. The voice coil of the vibration system moves in reciprocating mode in the magnet gap between the magnets. However, the magnetic flux leakage in the magnetic circuit system of the long stroke speaker is serious. The vibration amplitude of the voice coil is difficult to be controlled. The voice coil is easier to tear the vibrating diaphragm in larger vibration amplitude; and the sound quality is affected.

Therefore, it is necessary to provide a new speaker to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric exploded view of a speaker in accordance with an exemplary embodiment of the present disclosure.

FIG. 2 is a cross-sectional view of the speaker in FIG. 1.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

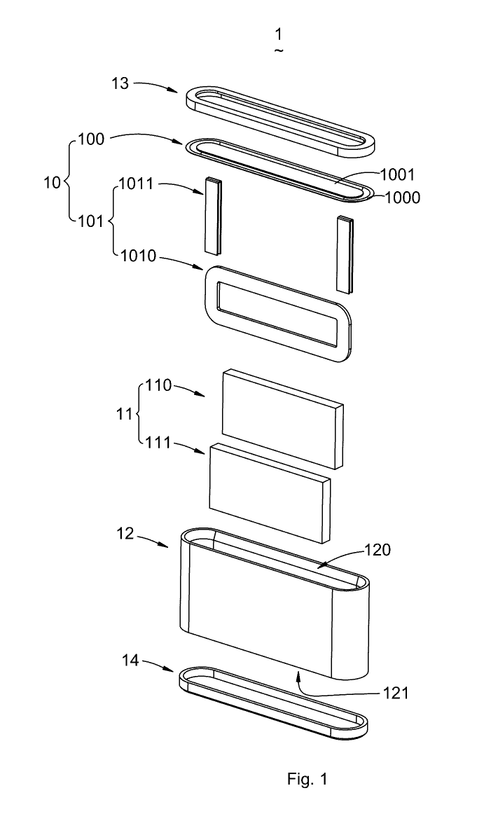

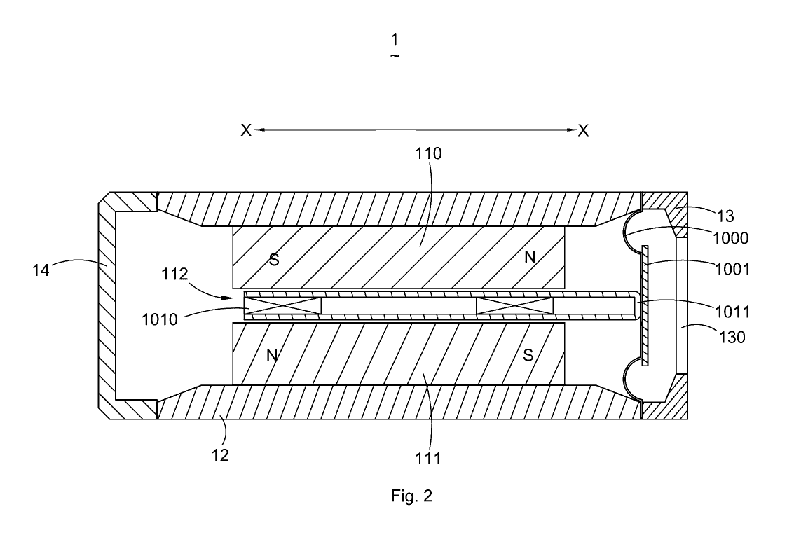

As shown in FIGS. 1 and 2, a speaker 1 in accordance with an exemplary embodiment of the present disclosure, includes a vibration system 10, a magnetic circuit system 11, a housing 12 for assembling the vibration system 10 and the magnetic circuit system 11, a front cover 13 and a rear cover 14 assembled on the housing 12 to create a space to accommodate the vibration system 10 and the magnetic circuit system 11.

The magnetic circuit system 11 includes a first permanent magnet 110 and a second permanent magnet 111 separated from the first permanent magnet 110, opposite magnetic poles of the first and second permanent magnets being faced to each other. The first permanent magnet 110 and the second permanent magnet 111 are fixed respectively on an inner surface of the housing 12. The gap between the first permanent magnet 110 and the second permanent magnet 111 is defined as a magnetic gap 112. Two magnetic poles of the first permanent magnet 110 and two magnetic poles of the second permanent magnet 111 are close to each other respectively. N-pole of the first permanent magnet 110 and S-pole of the second permanent magnet 111 are separated and faced each other. S-pole of the first permanent magnet 110 and N-pole of the second permanent magnet 111 are separated and faced each other. A distance between the N-pole of the first permanent magnet 110 and S-pole of the second permanent magnet 111 is equal to the spacing distance between S-pole of the first permanent magnet 110 and N-pole of the second permanent magnet 111. Therefore, the first permanent magnet 110 and the second permanent magnet 111 are parallel to each other.

The vibration system 10 includes a vibrating diaphragm 100 with an edge thereof fixed on the housing 12 and a flat voice coil 101 which drives the vibrating diaphragm 100 to vibrate. One end of the flat voice coil is suspended in the magnetic gap 112. The vibrating diaphragm 100 includes a suspension 1000 with a periphery thereof fixed on the housing 12, and a center dome top 1001 connected to the suspension 1000. The flat voice coil 101 includes a voice coil wire 1010 in flat and annular shape and a coil bracket 1011 with one end fixed on the center dome top 1001. The voice coil wire 1010 is fixed on the voice coil bracket 1011. The voice coil wire 1010 vibrates in reciprocating mode in the magnetic gap 112 between N-pole of the first permanent magnet 110 and S-pole of the second permanent magnet 111, and between S-pole of the first permanent magnet 110 and N-pole of the second permanent magnet 111 along the vibration direction X-X of the vibration system 10. The vibration of the voice coil wire 1010 is transferred to the vibrating diaphragm 100 through the coil bracket 1011 to drive the vibrating membrane 100 to vibrate and make sound. The first permanent magnet 110 and the second permanent magnet 111 are magnetized along the vibration direction X-X of the vibration system 10, i.e. magnetized along the major axis direction of the first permanent magnet 110 and the second permanent magnet 111.

The cross section of the housing 12 is in flat runway tubular shape. The housing 12 includes a front opening 120 for assembling the vibrating diaphragm 100 and a rear opening 120 corresponding to the front opening 121. The front opening 120 and the rear opening 121 are communicated with each other. The front cover 13 is installed on the front opening 120. The rear cover 14 is installed on the rear opening 121. The front cover 13 is provided also with a sound outlet 130. The circumferential edge of the vibrating diaphragm 100 is fixed between the front cover 13 and the housing 12.

In the speaker 1 disclosed above, the vibrating diaphragm 100 can have bigger vibration amplitude, so that the speaker 1 has a better low-frequency sound effect. In addition, the magnetic circuit system 11 needs only the first permanent magnet 110 and the second permanent magnet 111, which are separated with their opposite magnetic poles faced each other. The magnetic circuit system is much simple. The magnetic circuit system 11 is easier to be assembled.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A speaker, comprising:
a vibration system including a vibrating diaphragm and a flat voice coil for driving the vibrating diaphragm;
a magnetic circuit system including a first permanent magnet and a second permanent magnet, which are separated with opposite magnetic poles thereof facing each other;
a magnetic gap formed between the first permanent magnet and the second permanent magnet for partially receiving the flat voice coil;
a housing for accommodating the vibrational system and the magnetic circuit system; wherein
two magnetic poles of the first permanent magnet and two magnetic poles of the second permanent magnet are close to each other respectively, N-pole of the first permanent magnet is separated from and faces S-pole of the second permanent magnet, while S-pole of the first permanent magnet is separated from and faces N-pole of the second permanent magnet.

2. The speaker according to claim 1, wherein the housing includes a front opening for assembling the vibrating diaphragm and a rear opening corresponding to and communicating with the front opening.

3. The speaker according to claim 2 further including a front cover for the front opening and a rear cover for the rear opening, and an edge of the vibrating diaphragm is fixed between the front cover and the housing.

4. The speaker according to claim 1, wherein the vibrating diaphragm includes a suspension with a periphery thereof fixed on the housing, and a center dome top connected to the suspension.

5. The speaker according to claim 4, wherein the flat voice coil includes a voice coil wire and a coil bracket with one end fixed on the center dome top.

6. The speaker according to claim 1, wherein the first magnet and the second magnet are fixed respectively on an inner surface of the housing.

7. The speaker according to claim 1, wherein the first permanent magnet is parallel to the second permanent magnet.
